(19) United States
(12) Patent Application Publication
(10) Pub. No.: US 2006/0200989 A1
(43) Pub. Date: Sep. 14, 2006

(54) Rim

(76) Inventors: Gerald Possarnig, Graz (AT); Friedrich Sachl, Stallhofen (AT); Manfred Hermann, Ligist (AT)

Correspondence Address: DICKSTEIN SHAPIRO MORIN & OSHINSKY LLP, 2101 L Street NW, Washington, DC, 20037-1526, US

(21) Appl. No.: 11/392,855

(22) Filed: Mar. 30, 2006

Related U.S. Application Data
(63) Continuation of application No. PCT/AT04/00349, filed on Oct. 14, 2004.

(30) Foreign Application Priority Data
Oct. 14, 2003 (AT) A 1619/2003

(51) Int. Cl. B29C 44/02

(52) U.S. Cl. 29/894.35; 156/242

(57) ABSTRACT

With a rim (1) for wheels of vehicles, comprising a rim base serving for the reception of a support (7) of a tyre (5), said rim base is formed in one piece from a rim bottom (2) and rim flanges (3) limiting said rim bottom in a lateral manner, with the rim base consisting of a fibre composite material. In order to be able to easily manufacture a rim of this type, said rim withstanding also high strains, a preferably one-piece counter support (8) formed by a core (13) is embedded in the rim base, which counter support receives the support (7) of the tyre (5) and is rigidly connected to the rim base, wherein the counter support (8) is processed in a mechanical, especially machining, manner on the surfaces which come into contact with the support (7) of the tyre (5).

This is a continuation of International Application No. PCT/AT2004/000349, filed Oct. 14, 2004.

The invention relates to a rim for wheels of vehicles, in particular for bicycles or for vehicles fitted with running wheels of bicycles, comprising a rim base serving for the reception of a support of a tyre, formed in one piece from a rim bottom and rim flanges limiting said rim bottom in a lateral manner, which rim base is formed from a fibre composite material, as well as to a process for the production of such a rim.

With rims, the internal tyre pressure leads to a large strain on the rim flanges, especially in case of special rims such as, for example, for high-performance bicycles whose tyres are subject to a very high internal pressure. The production of such rims is very complex, and so far it has not been possible to successfully realize a favourable fibre orientation for such a rim profile, in particular, it has been impossible to successfully ensure a high fatigue strength under a static tyre pressure.

From US 2002/0108249 A1 and WO 02/26510 A1, it is known to produce rims of the initially described kind, using the so-called “collapsible core technique”. Thereby, a rim blank is inserted into a rim mould, with a collapsible core being provided between the rim bottom and the rim flanges, which collapsible core determines the shape of the space between the rim bottom and the rim flanges as the rim blank hardens in the rim mould. This type of process is time and money consuming, particularly since it is not only necessary for the collapsible cores, which have to extend across the circumference, to be radially divided but also to be divided on the rim level so that they can be removed and reused after the rim has hardened.

The insertion of these multi-piece cores, their alignment on the mould blank which has not yet hardened and the removal of those core parts after the rim has hardened turns out to be manually intricate and requires extra skill, particularly since the core parts are formations which have a small cross-sectional area and a relatively large length and thus are correspondingly fragile. The failure quota is correspondingly high.

From US 2002/0108249 A1, it is also known to provide one-piece cores. However, such one-piece cores have to be very flexible so that they can be removed from the space between the rim flanges and the rim bottom after the rim has hardened. After the rim has hardened, said cores preferably made from silicone thus have to be extracted from the rim with special pliers, which often can also cause damage to the finished rim.

Another problem associated with cores according to US 2002/0108249 A1 lies in that there are limits to the design of the cross-sectional shape of the cores, often leading to unfavourable radii at the roundings of the rim or at the edges on the rim, respectively, in particular at the transition between the rim bottom and the rim flange, which cannot be dimensioned in a load-compatible fashion.

From AT 401.638 B, a rim of the initially described kind is known, wherein two compartments divided by a partition wall are provided with a filling, material, with the radially outer compartment being open toward the outside. A foam insert serves as a filling material in the outer compartment.

The invention aims at avoiding these disadvantages and difficulties and has as its object to provide a rim of the initially described kind, which can be manufactured in a simple manner and with great safety, i.e., with mistakes being avoided. In particular, it should be possible to clearly reduce the production time of the rim in comparison with the prior art. Furthermore, it should be possible to design the rim in a load-compatible fashion without having to resort to any cost-intensive specific measures. It should always be possible to put the manufacturing process into practice in a stable manner and with high reproducibility. Furthermore, the rims should be fabricable in a particularly lightweight embodiment as usable, for instance, for racing bicycles. Hereby, it is again particularly important that the rim is extra stable despite the lightweight design so that it is possible, for example, to do without prestressed wire spokes for bicycles, or so that a high tyre pressure can be applied.

With a rim of the initially described kind, said object is achieved according to the invention in that a preferably one-piece counter support formed by a core is embedded in the rim base, which counter support receives the support of the tyre and is rigidly connected to the rim base, wherein the counter support is processed in a mechanical, especially machining, manner on the surfaces which come into contact with the support of the tyre.

By means of the counter support rigidly connected to the rim base, it is possible to realize specific load-compatible cross-sectional shapes of the rim without large efforts. The tyre is supported on the counter support, whereby the rim flanges can in turn be designed in a functionally adequate way so that extreme load peaks at the rim flanges can be avoided. Furthermore, the core which is not reusable can be designed in one piece and may have a stiffness and strength which, for the purpose of easy handling, is appropriately high.

A preferred embodiment is characterized in that the counter support rests both against the rim bottom and against the rim flanges and fills a space formed between the support of the tyre and the rim bottom and the rim flanges if the tyre is mounted onto the rim, with the rim bottom suitably being shaped so as to be curved in a convex manner toward the wheel hub, merging into the rim flanges with a continuous change in curvature.

An embodiment which is particularly favourable in terms of strength is characterized in that the cross-section of the rim bottom comprising the rim flanges is designed in an elliptical shape or in an oval form.

For high strains, a cavity oriented toward the wheel hub is suitably attached to the rim bottom, which cavity is limited by a fibre composite material formed integrally with the rim base and wherein the side walls of said cavity merge into the rim flanges without any irregularities.

As a material for the core, in particular a thermoplastic material or a thermosetting material or a natural material such as wood as well as optionally a modified natural material may come into consideration, with the core preferably containing a filling material, in particular a filling material of a metallic, organic and/or mineral nature.

A process for the production of a rim according to the invention, wherein a rim blank is inserted into a rim mould and is itself formed there into the desired rim shape, whereby the material used is hardened, with the rim blank having a rim base formed from a fibre composite material and comprising a rim bottom and rim flanges limiting said rim bottom in a lateral manner, is characterized in that, in the space limited by the rim bottom and the rim flanges, a dead core filling said space is inserted prior to the insertion into the rim mould and that the core is processed in a mechanical, especially machining, manner after the rim blank has hardened, whereby a counter support receiving the support of a tyre is formed.

When processing the core in a mechanical manner, preferably also the edges of the rim flanges are processed in a mechanical manner.

A preferred process variant is characterized in that, on the inside of the rim blank which is limited by the rim bottom and the rim flanges, a resin causing the core to adhere to the rim blank is provided in liquid form in a processing step during the contact of said inside with the core.

Preferably, a synthetic material is used for the core, wherein the surface of said synthetic material can be chemically activated for the purpose of better bonding properties. Said activation of the surface is suitably effected by flame treatment and/or roughening and/or etching with suitable chemicals and/or corona treatment.

### BRIEF DESCRIPTION OF THE DRAWINGS

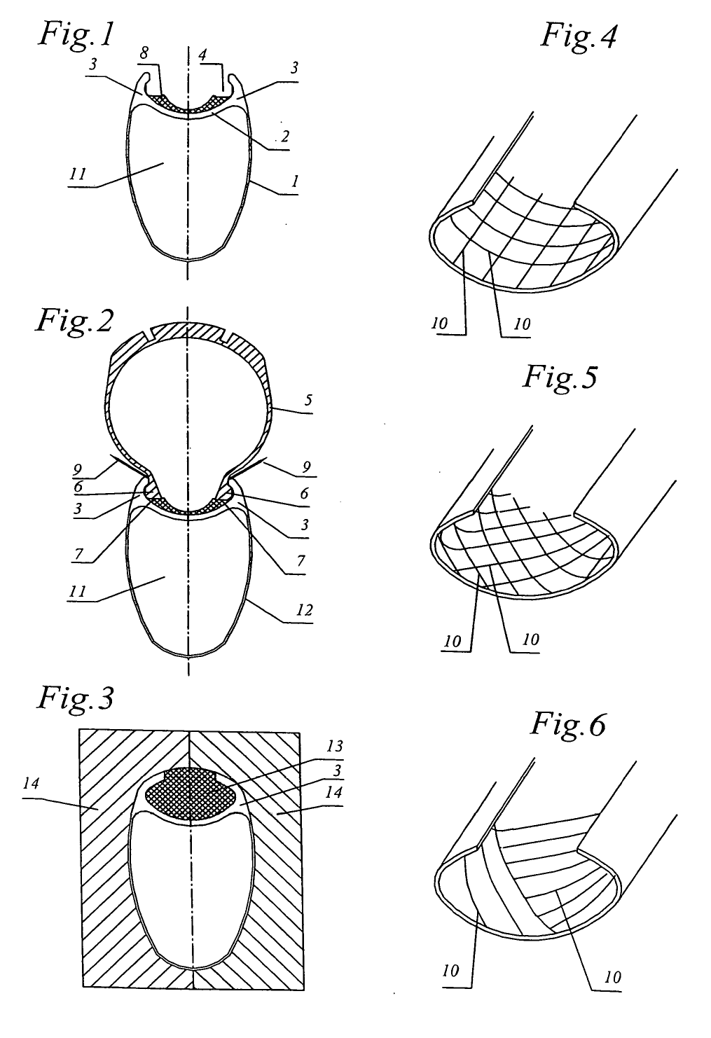

The invention is illustrated in further detail below by way of several exemplary embodiments, wherein FIG. 1 shows a cross-section through a rim for bicycles, in particular racing bicycles, FIG. 2 shows a cross-section through the rim with a tyre being fitted and FIG. 3 shows a cross-section through a rim mould with a rim blank being inserted. In FIGS. 4, 5 and 6, variants of the tread plies are shown with the inserted fibres having different orientations.

### DETAILED DESCRIPTION OF THE PREFERRED EMBODIMENT

It is within the scope of the invention to use a rim according to the invention also for other types of vehicles, in particular also for motor-driven vehicles.

The rim illustrated in FIG. 1 has a rim bottom which is limited by rim flanges 3 projecting laterally in a radial direction. The tyre 5 with its tyre beads 6 is insertable in the space 4 between the rim flanges 3 and the rim bottom 2, wherein a counter support 8 receiving the supports 7 of the tyre 5 and being rigidly connected to the rim base is provided in the rim base formed by the rim bottom 2 and the rim flanges 3. The tyre beads 6 are fully supported on said counter support.

By means of the counter support 8, it is possible to form the rim bottom 2 in a strongly arched manner, with the rim bottom 2 preferably forming a partially elliptical cross-section with the rim flanges 3 and the rim flanges 3 merging into the rim bottom 2 without any irregularities. The 1 rim itself is formed from a fibre composite material, and by means of the counter support 8, it is possible to optimally design the cross-section of the rim base for the emerging forces caused by the tyre pressure, which are illustrated in FIG. 2 by arrows 9. As can be seen in FIGS. 4, 5 and 6, the fibres 10 of the fibre cross-ply of the fibre composite material can extend in a circumferential direction and transversely thereto (FIG. 4) or can be placed in a crosswise manner or also crosswisely in layers (cf. FIGS. 5 and 6).

As can be seen in FIG. 1, a cavity 11 oriented toward the wheel hub (not illustrated) is radially attached to the rim bottom 2 toward the inside, which cavity is limited by a composite material formed integrally with the rim base and wherein the side walls 12 of said cavity merge into the rim flanges 3 without any irregularities.

In order to produce the rim 1 according to the invention, the following procedure is used:

At first, the rim blank is formed from the fibre cross-plies 10 preimpregnated with resin, with a core 13 being inserted between the rim bottom 2 and the rim flanges 3, which core completely fills the space 4 of the rim base formed by the rim bottom 2 and the rim flanges 3.

Said rim blank is then inserted into the rim mould 14 and is formed there into the desired cross-sectional shape of the rim, whereby the material used is hardened by the impact of heat, the core 13 preferably adhering to the rim flanges 3 and the rim bottom 2. This can be caused, for example, by a liquid resin which is present between the core 13 and the rim bottom 2 and the rim flanges 3. Since the core 13 can be manufactured in one piece and from a solid material, the moulding of the rim blank and the insertion of the rim blank into the rim mould 14 turn out to be comparatively simple.

After the insertion of the rim blank into the rim mould 14, the cavity 11 attached to the rim bottom 2 toward the wheel hub is formed via the pressure bag process so that the side walls 12 of said cavity 11 press against the rim mould 14.

After hardening, the rim 1 is removed from the rim mould 14 and the core 13 is machined until it has adopted the desired outline as a counter support 8 against the supports 7 of the tyre 5.

Suitably, the core 13 is made from an easily machinable material such as, e.g., from a thermoplastic or thermosetting material. The following materials can be considered therefor: ABS, PA, PP, PVC as thermoplastic materials and, e.g., epoxide, PU, polyester, vinyl ester as thermosetting plastics. Furthermore, the core 13 can also be formed from metal or from a natural material or a modified natural material such as, e.g., wood or a pressboard material.

With all materials of the core 13, filling materials of a metallic, organic and mineral nature can be added alone and in combination in order to improve the properties (temperature stability, diffusion dependency with respect to tyre filling gases, machinability, colour, resistance to scratching, for reducing the specific weight, etc.).

The particular advantage of the rim 1 according to the invention is its load-compatible support structure. If an appropriate material is selected as the core material, it is also possible to achieve hermetic sealing, which is important especially for tubeless tyres 5. This property cannot be achieved by fibre composite materials alone.

What is claimed is:

1. A rim for wheels of vehicles, in particular for bicycles or for vehicles fitted with running wheels of bicycles, comprising a rim base serving for the reception of a support of a tire, formed in one piece from a rim bottom and rim flanges limiting said rim bottom in a lateral manner, characterized in that a preferably one-piece counter support which is formed by a dead core used during production and filling the space limited by the rim bottom and the rim flanges and which receives the support of the tire and is rigidly connected to the rim base, is embedded in the rim base formed from a fiber composite material, wherein the counter support is processed in a mechanical, especially machining, manner on the surfaces which come into contact with the support of the tire.

2. A rim according to claim 1, characterized in that the counter support rests both against the rim bottom and against the rim flanges and fills a space formed between the support of the tire and the rim bottom and the rim flanges if the tire is mounted onto the rim.

3. A rim according to claim 1, characterized in that the rim bottom is shaped so as to be curved in a convex manner toward the wheel hub, merging into the rim flanges with a continuous change in curvature.

4. A rim according to claim 1, characterized in that the cross-section of the rim bottom comprising the rim flanges is designed in an elliptical shape or in an oval shape.

5. A rim according to claim 1, characterized in that a cavity oriented toward the wheel hub is attached to the rim bottom, which cavity is limited by a fiber composite material formed integrally with the rim base and wherein the side walls of said cavity merge into the rim flanges without any irregularities.

6. A rim according to claim 1, characterized in that the core forming the counter support is formed from a thermoplastic material or from a thermosetting material or from a natural material such as wood, optionally from a modified natural material.

7. A rim according to claim 1, characterized in that the core contains a filling material, in particular a filling material of a metallic, organic and/or mineral nature.

8. A process for the production of a rim according to claim 1, wherein a rim blank is inserted into a rim mould comprising a core forming the shape of the rim base and is formed therein into the desired cross-sectional shape of the rim, whereby the rim material used is hardened, with the rim blank having a rim base formed from a fiber composite material and comprising a rim bottom and rim flanges limiting said rim bottom in a lateral manner, characterized in that, in the space limited by the rim bottom and the rim flanges, a dead core filling said space is inserted prior to the insertion into the rim mould and that the core is processed in a mechanical, especially machining, manner after the rim blank has hardened, whereby a counter support receiving the support of a tire is formed.

9. A process according to claim 8, characterized in that, when processing the core in a mechanical manner, also the edges of the rim flanges are processed in a mechanical manner.

10. A process according to claim 8, characterized in that, on the inside of the rim blank which is limited by the rim bottom and the rim flanges, a resin causing the core to adhere to the rim blank is provided in liquid form in a processing step during the contact of said inside with the core.

11. A process according to claim 8, characterized in that a chemically activatable material is used for the core.

12. A process according to claim 11, charcterized in that a thermoplastic or thermosetting material is used for the core.

13. A process according to claim 11, characterized in that the chemical activation of the core is effected by flame treatment and/or roughening and/or chemical etching and/or corona treatment of the surface of the core.
